(19) United States
(12) Patent Application Publication
(10) Pub. No.: US 2026/0081932 A1
(43) Pub. Date: Mar. 19, 2026

(54) AUTOMATED DISCOVERY OF MALICIOUS WEBSITE CAMPAIGN INFRASTRUCTURE USING GRAPH NEURAL NETWORKS

(71) Applicant: Palo Alto Networks, Inc., Santa Clara, CA (US)

(72) Inventors: Mohamed Yoosuf Mohamed Nabeel, San Jose, CA (US); Keerthiraj Nagaraj, Santa Clara, CA (US); Shehroze Farooqi, Santa Clara, CA (US); Oleksii Starov, Sunnyvale, CA (US)

(21) Appl. No.: 18/890,630

(22) Filed: Sep. 19, 2024

(51) Int. Cl. H04L 9/40

(52) U.S. Cl. CPC H04L 63/1416

(57) ABSTRACT

A graph neural network (GNN) based pipeline discovers direct and indirect relationships among domains from shared infrastructure and threat intelligence. The pipeline builds a knowledge graph starting with nodes representing a set of malicious domains and adds nodes representing related domains and network artifacts of the malicious domains. The pipeline extracts values of features of domains to enrich the nodes. The pipeline transforms the knowledge graph from heterogeneous nodes to homogenous nodes by transforming the qualitative relationships expressed at least partially with the network artifact nodes into quantitative relationships expressed with edges between domain nodes. The pipeline generates feature vectors for each of the nodes based on the domain features values and with these trains a GNN to learn an embedding. The pipeline then clusters the graph embeddings generated by the trained GNN model and detects malicious domain campaigns based on the clustering.

### BACKGROUND

The disclosure generally relates to data processing and computing arrangements based on computational models (e.g., CPC subclass G06N and CPC subclass G06F 16).

A cyberthreat campaign, sometimes “malicious campaign,” is an organized set of activities to achieve a cyberthreat purpose or goal (e.g., data exfiltration, unauthorized device/network access, fraud, etc.). A typical delivery mechanism for a cyberthreat campaign is websites. Thus, a cyberthreat campaign that leverages websites uses a variety of domain names. Threat actors leverage domain names (“domains”) for phishing campaigns, malware delivery campaigns, data harvesting campaigns, etc. These are sometimes referred to as malicious domain campaigns.

### BRIEF DESCRIPTION OF THE DRAWINGS

Embodiments of the disclosure may be better understood by referencing the accompanying drawings.

FIG. 1 is a conceptual diagram of a graph neural network (GNN)-based pipeline that detects malicious domain campaigns.

FIG. 2 is a flowchart of example operations for detecting malicious domain campaigns with a GNN-based detection pipeline.

FIG. 3 is a flowchart of example operations for transforming a heterogeneous knowledge graph into a homogenous knowledge graph by transforming qualitative relationships into quantitative relationships between domain nodes.

FIG. 4 is a flowchart of example operations for training a GNN model to learn a graph embedding space according to unsupervised learning.

FIG. 5 is a flowchart of example operations for detecting malicious domain campaigns based on the clustering of graph embeddings.

FIG. 6 is a flowchart of example operations for generating an infrastructure fingerprint for detected malicious domain campaigns.

FIG. 7 depicts an example computer system with a GNN-based malicious domain campaign detection pipeline.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Overview

Threat actors often use multiple domains and network artifacts (e.g., certificates, network addresses, etc.) in a malicious domain campaign. While a malicious domain campaign will often have commonalities in infrastructure and threat actors tend to reuse infrastructure across campaigns, these “dots” connecting the domains to reveal a malicious domain campaign are rarely discernable without machine assistance. While signature-based detection is used for detection of malicious domains, the multitude of malicious domain campaigns and numerous variations in domains present substantial challenges to extrapolating from individual malicious domain detection with signature-based detection to detecting malicious domain campaigns.

A graph neural network (GNN) model based pipeline has been created to detect malicious domain campaigns based on discovering the latent and obscured relationships among domains in the morass of information. The GNN model based pipeline discovers direct and indirect relationships among domains evidenced by shared infrastructure and threat intelligence. The pipeline builds a knowledge graph starting with nodes representing a set of malicious domains and adds nodes representing related domains and network artifacts of the malicious domains. The pipeline extracts, from infrastructure information and threat intelligence, values of features of domains to enrich the nodes. The pipeline transforms the knowledge graph from heterogeneous nodes to homogenous nodes by transforming the qualitative relationships expressed at least partially with the network artifact nodes into quantitative relationships expressed with edges between domain nodes. The transformation reveals indirect relationships between domain nodes via network artifact nodes that share infrastructure and captures the various qualitative relationships in terms of relationships and strength of relationships. In addition, the pipeline generates feature vectors for each of the nodes based on the domain features values of each node. The pipeline then trains a GNN model to learn an embedding space with the homogeneous knowledge graph and feature vectors. This allows the GNN model to learn the embedding space based on the structural relationships and feature vectors. The pipeline then clusters the graph embeddings generated by the trained GNN model and detects malicious domain campaigns based on the clustering.

### Example Illustrations

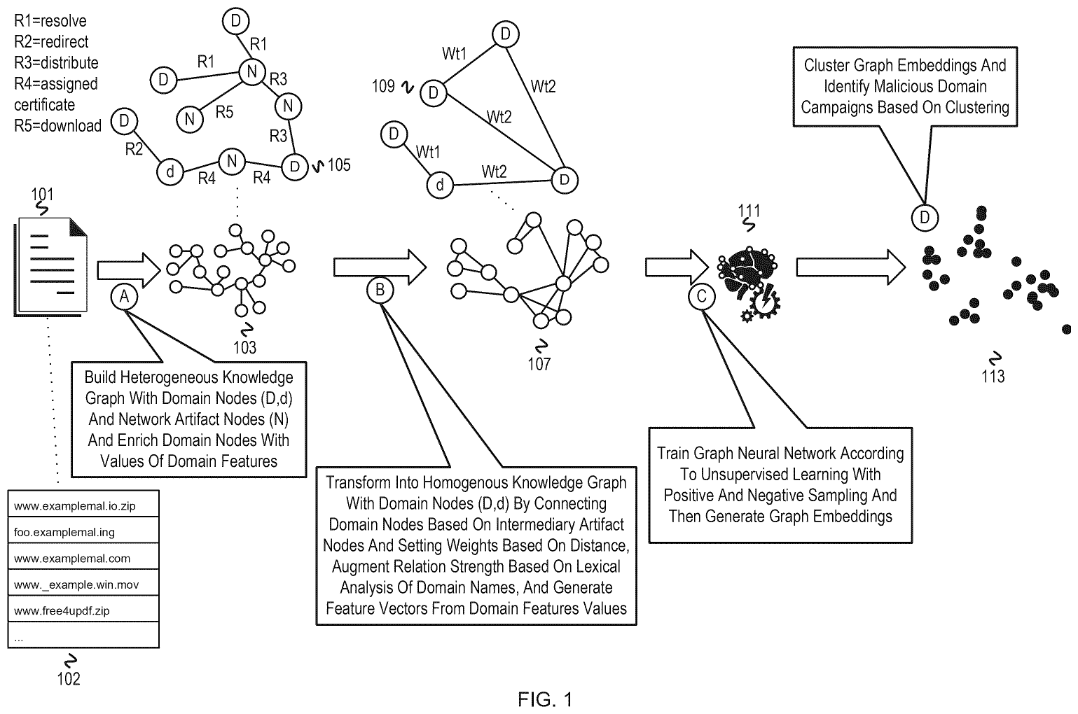

FIG. 1 is a conceptual diagram of a GNN-based pipeline that detects malicious domain campaigns. FIG. 1 is annotated with a series of letters A-D that each represent a stage of one or more operations of the pipeline. The operations refer to a pipeline as performing the operations, but “pipeline” is being used as representative for components that form the pipeline and may be known individually, such as a graph builder or a clustering service, for are arranged in the manner disclosed herein to form the pipeline. Although these stages are ordered for this example, the stages illustrate one example to aid in understanding this disclosure and should not be used to limit the claims. Subject matter falling within the scope of the claims can vary from what is illustrated.

At stage A, the pipeline builds a first knowledge graph 103 from data 101 that includes threat intelligence and domain information. The data 101 includes a list of malicious domains 102. FIG. 1 depicts the list of malicious domains 101 as including illustrative examples www.examplemal.io.zip, foo.examplemal.ing, www.examplemal.com, www.example.win.mov, and www.free4updf.zip. These few illustrative examples use example domains with attributes observed in malicious domain campaigns include certain top level domains (TLDs) and nested TLDs. The data 101 will also include domain name system (DNS) registration information and information from passive DNS records that can include network artifacts corresponding to infrastructure. Threat intelligence may also be included in the data 101 and indicate network addresses associated with malware distribution and/or destinations of malware. The pipeline builds the first knowledge graph 103 with domain nodes and network artifact nodes, yielding a heterogeneous knowledge graph with respect to the types of entities represented by nodes in the graph. The pipeline initially creates nodes representing the malicious domains and then adds nodes representing other domain nodes and network artifacts related to the malicious domains. The pipeline determines the related domains, network artifacts, and relationships with the initial malicious domains from the data 101.

FIG. 1 illustrates a subgraph 105 of the graph 103. In the subgraph 105, the initial malicious domains are represented with ‘D’ nodes. The subgraph 105 depicts a related domain node related to a malicious domain node by redirection as represented by the relationship R2. The subgraph 105 depicts network artifact nodes with ‘N’ and those network artifact nodes having various relationships with the malicious domains and the redirect domain. A domain node connected to a network artifact node with a R1 relationship indicates a domain resolving to a network address. A network artifact node connected to another network artifact node with a R3 relationship indicates distribution of malware from a network address. A domain node connected to a network artifact node with a R4 relationship indicates a domain having a certificate for authentication. A network artifact node connected to a network artifact node with a R5 relationship indicates malware being loaded onto a device assigned a network address.

In addition to establishing structure, the pipeline enriches the domain nodes of the graph 103. From the data 101, the pipeline extracts values of features of domains. The values of various features of a domain provide a rich, qualitative description of a domain which increases the opportunity to discover relations between domains. The domain features values can be retrieved from passive DNS records, host registration information, certificate information, and content based features.

At stage B, the pipeline builds a second knowledge graph 107. Building the second knowledge graph 107 is also referred to herein as transforming the first knowledge graph 103 into the second knowledge graph 107 because the non-domain nodes (or network artifact nodes) are converted into edges and/or edge weights between the domain nodes. This transformation encodes indirect relationships among domains via network artifacts into strength of relationships among the domains, which yields a homogeneous graph of nodes that only represent domains. The pipeline traverses the first knowledge graph 103 to build the second knowledge graph 107 or transform the first knowledge graph into the second knowledge graph. Assuming the pipeline is configured to process a path between two domain nodes that includes a single network artifact node as a strong relationship or connection, then the pipeline converts the network artifact node into an edge between the domain nodes that are endpoints of the path and assigns the edge a weight Wt1 which represents a strong connection or relationship. Assuming the pipeline is configured to process a path between two domain nodes that includes a sequences of two network artifact nodes as a weaker relationship or connection, then the pipeline converts the network artifact node into an edge between the domain nodes that are endpoints of the path and assigns the edge a weight Wt2 which represents a weaker connection or relationship. For this illustration, the pipeline treats a path between domain nodes separated by more than 2 network artifact nodes in sequence as too distant for conversion. FIG. 1 includes a subgraph 109 of the graph 107. The subgraph 109 includes the domain nodes of the subgraph 105, but edges have been added in place of some of the network artifact nodes. Also, edges of the subgraph 109 are depicted with weights instead of types of relationships. In addition to the weights assigned to edges based on structural relationships, the pipeline can augment relation strength based on lexical analysis of domains. For instance, the pipeline can add additional weight to an edge between domain nodes corresponding to domains with a sufficient similarity as defined by a distance threshold.

The pipeline also generates feature vectors for the domain nodes. For each domain node, the pipeline extracts the values that were associated with the node when building the first knowledge graph and generates a feature vector from the values.

At stage C, the pipeline trains a GNN model 111 according to an unsupervised learning technique. The GNN model 111 is trained to learn an embedding space based on the structural relationships captured by the graph 107 and corresponding feature vectors. The trainer invoked by the pipeline is configured to calculate loss as a function of a difference between similarities of positive samples of graph embeddings generated by the GNN model 111 from the graph 107 and corresponding feature vectors and dissimilarities of negative samples. After the GNN model 111 has been trained, the GNN model 111 generates graph embeddings for clustering. Updating the GNN model 111 based on this loss function optimizes the condition of the positive samples being near each other in an embedding space and the condition that the negative samples be further from each other in the embedding space. In other words, the loss function causes the GNN model 111 to learn an embedding space in which the positive samples are closer to each other and the negative samples are further from each other.

At stage D, the pipeline clusters the graph embeddings and detects one or more malicious campaigns with the clustering 113 of graph embeddings. The pipeline runs a clustering program on the graph embeddings and processes each cluster as a potential malicious campaign. Embodiments can identify each cluster as a malicious campaign or perform additional processing to increase accuracy of malicious domain campaign detection as described in the example operations in the flowcharts.

The example nodes and relationships described in FIG. 1 for the heterogeneous knowledge graph are provided as an example to aid in explaining the technology. Implementations are not limited to the information used in the examples. With respect to structure, implementations are not limited to two types of nodes (i.e., domain and network artifact nodes) and the example relationships used in the FIG. 1 description. Additional information can be obtained and reflected in the first knowledge graph. For example, nodes can be added for e-mail addresses and keywords with “hosted” or “detected” relationships. With respect to features, other features can be discovered as helpful in revealing related domains, such as manually crafted features or features identified by a foundation model.

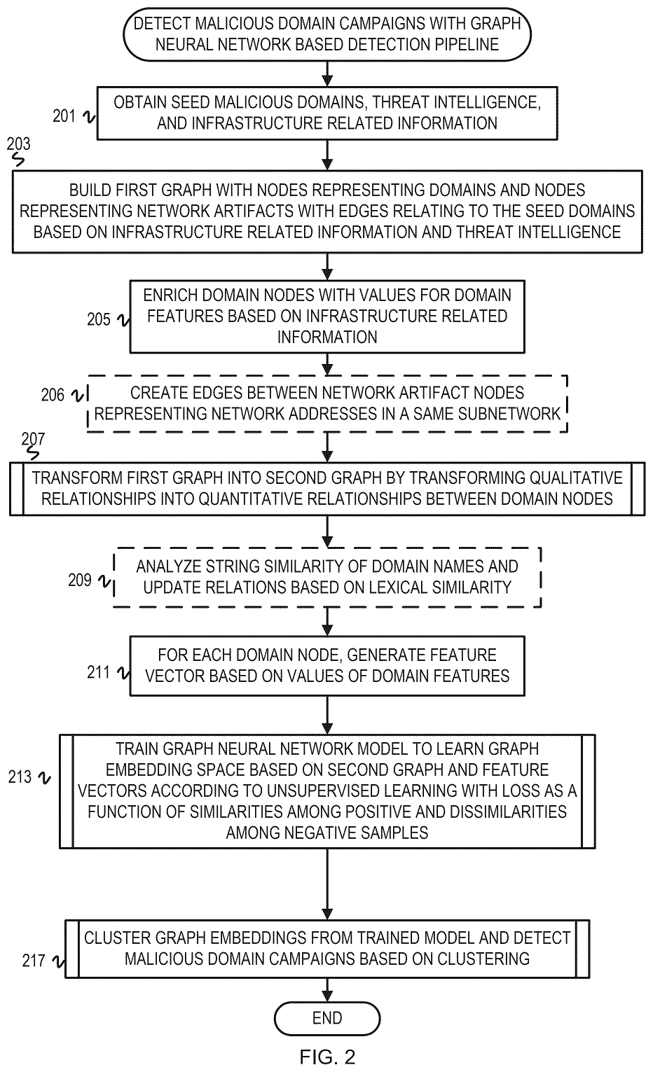

FIGS. 2-5 depict flowcharts of example operations that elaborate on the stages depicted in FIG. 1. The example operations are described with reference to the pipeline for consistency with the earlier figure and/or ease of understanding. An example operation depicted in a dashed line indicates that the example operation is optional, such as an optimization operation. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 2 is a flowchart of example operations for detecting malicious domain campaigns with a GNN based detection pipeline. Running or executing the pipeline includes creation of two graphs and training a GNN model. Some components of the pipeline may run locally or be remotely called. In other words, the components of the pipeline may be distributed.

At block 201, the pipeline obtains seed malicious domains, threat intelligence, and infrastructure related information. If not already retrieved and organized into a database for consumption by the pipeline, the pipeline will query various services and/or databases to retrieve and parse host information, registration information, DNS records, etc. for each of the seed malicious domains. In some cases, another tool or system has already created a graph of known malicious domains. For construction of the first knowledge graph, the pipeline at least retrieves the network artifacts for each of the malicious domains. The data from various data sources will have been processed to determine any certificates assigned to a domain by a certificate authority, resolves to network addresses from DNS records, redirects to other domains from DNS records, and related malware activity from threat intelligence data. Implementations may analyze some of this information, such as passive DNS records, to identify domains related to the malicious domains. In addition, the pipeline can identify and include subdomains of the malicious domains.

At block 203, the pipeline builds a first graph with nodes representing domains and nodes representing network artifacts. The pipeline builds the graph with edges relating nodes of the known malicious domains to other domain nodes (i.e., nodes representing domains not indicated in the known malicious domains list) and network artifact nodes based on infrastructure related information and threat intelligence. For instance, the pipeline determines from the DNS records that malicious domain X redirects to domain Y. The pipeline will add an edge between nodes representing domains X and Y and indicate the redirect relationship with the edge. When the pipeline encounters indication that a malicious domain X resolves to a network address 203.113.0.22, the pipeline adds a network artifact node representing the network address and an edge with a relationship value (e.g., string, integer, etc.) corresponding to network address resolution. When the pipeline encounters indication that a malicious domain X has been assigned a certificate ABC, the pipeline adds a network artifact node representing the certificate and an edge with a relationship value corresponding to assignment of the certificate to the domain X. If the threat intelligence data includes information that relates malware signatures or phishing kit signatures to domains, then this information is also captured in the graph. The pipeline adds a network artifact node representing the malware signature and connects the nodes with an edge indicating the relationship, such as downloads or distributes. Embodiments can also prune the first graph after adding the nodes and edges and before enriching the domain nodes. The pipeline can prune the first graph to remove noisy domain nodes (i.e., domain nodes with a number of edges beyond a threshold defined for a noisy domain) and/or remove low yield connected components. A low yield connected component is a connected component with a number of nodes that does not satisfy a defined threshold correlated with sufficient connected component size to provide helpful information that outweighs the computational resources expended analyzing the connected component (e.g., a connected component with only 4 nodes).

At block 205, the pipeline enriches the domain nodes with values for domain features based on infrastructure related information and threat intelligence. Depending upon implementation, enriching a domain node with the feature values can be writing the values into the data structure underlying a node or associating/referencing the feature values from the node data structure. Domain features can be categorized into lexical features, hosting features, domain registration or WHOIS features, certificate features, and content-based features. Examples within each category of domain features are given below.
Lexical features—number of brand keywords present, number of suspicious keywords present, reputation of the TLD, and number of hyphens in the domain name.
Hosting features—number of times the domain is queried, the number of network addresses hosting the domain, domain hosting duration, and number of authoritative name servers.
Domain registration features/WHOIS features—time since registration, time to expiration, registrar, privacy protection setting, and domain age.
Certificate features—validation period, certificate issuer, certificate type, and number of domains in a multi-domain certificate.
Content based features—presence of a web form, quantity of scripts in the page (e.g., quantified by script tags), number of iframes, length of the page (e.g., measured in bytes), and number of metadata tags.
Since all domains represented in the first graph are not necessarily one of the initial malicious domains, the pipeline may query other databases or external services to retrieve the feature values.

At block 206, the pipeline creates edges between network artifact nodes representing network addresses in the same subnetwork. While optional, the pipeline can add additional relationship information to the graph based on membership within the same domain. The pipeline can analyze the network addresses represented in the first graph and add edges between network artifact nodes representing network addresses within the same subnet, for example a same /24 subnet.

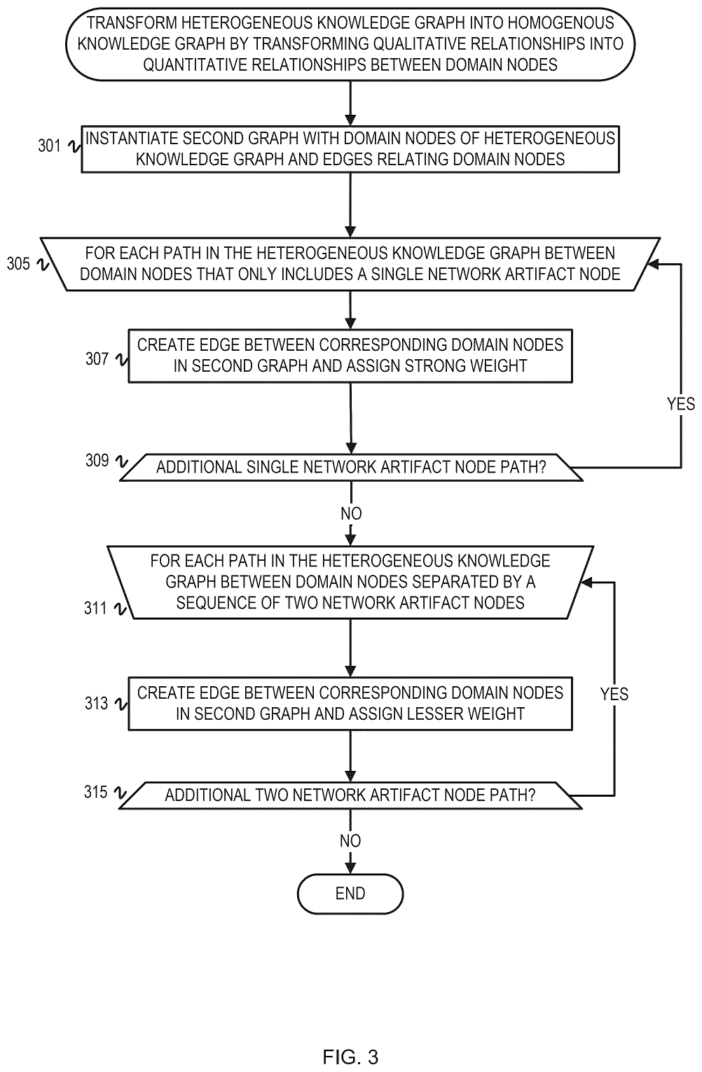

At block 207, the pipeline transforms the first graph into a second graph by transforming qualitative relationships into quantitative relationships between domain nodes. The transformation yields a second graph with domain nodes with edges and weights expressing the relationships through network artifact nodes and strength of those relationships. FIG. 3 provides example operations corresponding to the transformation.

At block 209, the pipeline analyzes string similarity of domain names and updates relations based on string similarity. String similarity can be based on edit distance, such as Levenshtein distance or Hamming distance. A configurable threshold demarcates similarity sufficient for an edge to be added from insufficient similarity. The pipeline examines string similarity of each pair of domains in the second graph and adds an edge relating the nodes of the compared domains if their similarity is sufficient. Embodiments can limit the string similarity analysis to already connected domains. Embodiments can set different thresholds for domains already related and those domains that are not related. If an edge is added, it can be assigned a “strong” weight which will be discussed further in FIG. 3. Alternatively, the weight of an existing edge can be increased to reflect the string similarity.

At block 211, the pipeline generates a feature vector for each domain node based on values of domain features. The pipeline uses the domain feature values that were previously associated with the domains in the enrichment operation to generate feature vectors.

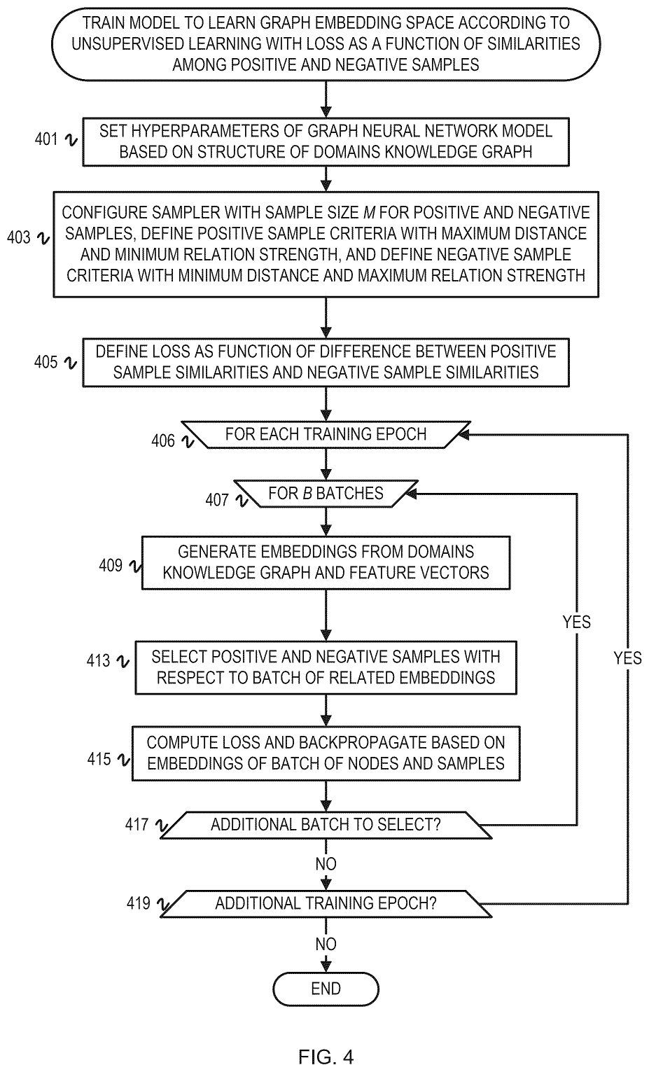

At block 213, the pipeline performs unsupervised training of a GNN model for the GNN model to learn a graph embedding space based on the second graph and the feature vectors. The pipeline uses a loss function that computes loss based on a difference in similarities of positive and dissimilarities in negative samples of graph embeddings generated by the GNN model during training. FIG. 4 depicts example operations that elaborate on the GNN model training.

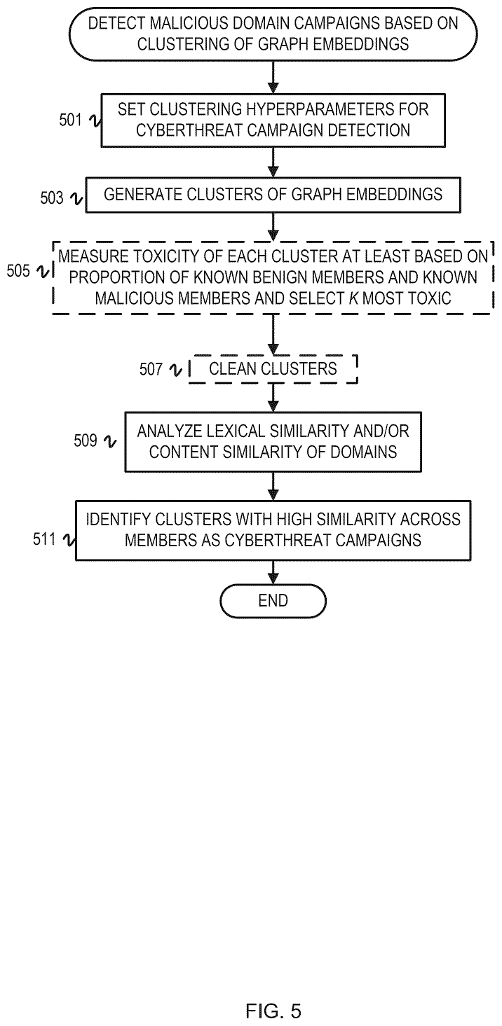

At block 217, the pipeline clusters the graph embeddings from the trained GNN model and detects malicious domain campaigns based on the clustering. The pipeline can indicate each cluster as a potential malicious domain campaign or analyze the clusters to further inform selection of a cluster(s) as a potential malicious domain campaign. FIG. 5 depicts example operations that elaborate on analysis and/or filtering of the clusters for malicious domain campaign detection.

FIG. 3 is a flowchart of example operations for transforming a heterogeneous knowledge graph into a homogenous knowledge graph by transforming qualitative relationships into quantitative relationships between domain nodes. In FIG. 2, the heterogeneous knowledge graph is referred to simply as the first graph while the homogeneous knowledge graph is referred to as the second graph. As previously described, the first graph expresses relationships between different types of nodes with different types of relationships. The transformation yields a new graph, the second graph, which condenses these different relationships into relation or connection strengths. Numerous graph building implementations are possible. These example operations only provide one example with a primary purpose of illustrating how the non-domain nodes and edges of the first graph can be converted into edges and/or connection strength in the second graph. For instance, the example operations add an edge for each discovered relationship. Embodiments can aggregate the edges and their assigned weights into a single edge with a sum of the weights assigned as the weight of the single edge.

At block 301, the pipeline instantiates a second graph with domain nodes of the first graph and edges directly relating the domain nodes in the first graph. Depending upon the data structure implementing the first graph, the pipeline can copy the domain nodes of the first graph and replicate edges that directly connect those domain nodes. The pipeline can also traverse the first graph and copy each domain node traversed and each edge traversed that directly connects domain nodes to build the second graph.

At block 305, the pipeline begins traversing the first graph to search for each path that includes a single network artifact node connecting domain nodes. For each path found in the first graph, the pipeline updates the second graph to indicate a domain-to-domain relationship based on the domain-network artifact-domain relationship in the first graph.

At block 307, the pipeline creates an edge between corresponding domain nodes in the second graph and assigns a “strong” weight. The strong weight is a configurable value chosen to quantify a strong relationship between domains (e.g., a 1 on a 0 to 1 scale). A strong weight is assigned since the relationship is a direct relationship between domains.

At block 309, the pipeline determines whether there is another path with a single network artifact node between domain nodes. If there is another single network artifact node path, then operational flow returns to block 305. Otherwise, operational flow proceeds to block 311. Although this is expressed in terms of the single network artifact node path that remains, implementations likely traverse the graph in accordance with a path search algorithm and end when the first graph has been traversed.

At block 311, the pipeline begins traversing the first graph to search for each path that includes a sequence of two network artifact nodes in a path between domain nodes. For each path found in the first graph, the pipeline updates the second graph to indicate a domain-to-domain relationship based on the domain-network artifact-network artifact-domain relationship in the first graph.

At block 313, the pipeline creates an edge between corresponding domain nodes in the second graph and assigns a lesser strength weight. The lesser strength weight is another configurable value chosen to quantify a relationship between domains that has less strength than a direct domain-domain relationship in the first graph (e.g., 0.25). In other words, the quantified relationship/connection strength is less because it is a presumed connection based on a commonality of a network artifact.

At block 315, the pipeline determines whether there is another path with a sequence of two network artifact nodes between domain nodes. If there is another two network artifact node path, then operational flow returns to block 311. Otherwise, operational flow of FIG. 3 ends. Similar to the traversal expressed in block 305 and 309, implementations likely use a path search algorithm with the goal of finding every two network artifact node path between domain nodes in the first graph.

FIG. 4 is a flowchart of example operations for training a GNN model to learn a graph embedding space according to unsupervised learning. The specific implementation for training can vary, for example choosing batch training, depending upon various factors, such as available compute resources. The example operations refer to the pipeline as performing the operations, but a trainer is configured and invoked to train the GNN model.

At block 401, the pipeline sets hyperparameters of a graph neural network based on the structure of the input domains knowledge graph. The input domains knowledge graph is the homogeneous knowledge graph produced from the transforming operations applied to the heterogeneous. Examples of the hyperparameters to set include the internal embedding size which is dependent on the size of the feature vectors and graph, the number of epochs, the number of internal layers (e.g., 2-4), the activation function (e.g., the rectifier linear unit (ReLU), the exponential linear unit (ELU), etc.), the dropout probability, and an optimization algorithm (e.g., adaptive gradient algorithm, ADADELTA, etc.).

At block 403, the pipeline configures parameters of a sampler. The pipeline configures the sampler with a sample size m for positive samples and m for negative samples. The pipeline also defines a positive sample criteria with a maximum distance and minimum relation strength. The positive sample criteria define what can be considered an immediate neighborhood. The pipeline defines negative sample criteria with a minimum distance and maximum relation strength. The negative sample criteria define what can be considered outside of the immediate neighborhood.

At block 405, the pipeline defines a loss as a function of difference between positive sample similarities and negative sample dissimilarities.

Loss=—(similarity of positive nodes)—(inverse similarity of negative nodes)

At block 406, the pipeline begins one of the training epochs and repeats until the number of training epochs has been satisfied.

At block 407, the pipeline begins a training iteration and repeats for each of B batches of graph embeddings. The GNN implementation used by the pipeline (i.e., a GNN library) will select a batch according to the selected GNN algorithm. For instance, a GNN implementation may select connected components in the graph until the batch size is satisfied and iterate through batches until all connected components of the graph are considered in training. In addition to the number of batches, a batch size is defined as larger than the sample size m.

At block 409, the pipeline invokes the GNN to generate graph embeddings. The pipeline provides the domains knowledge graph and feature vectors of the domains represented in the domains knowledge graph as input. In terms more specific to a GNN, the pipeline (or trainer invoked by the pipeline) runs the forward pass of the GNN which involves aggregating messages of neighboring nodes (e.g., averaging embeddings of neighbors of a current node although a minimum or maximum could be used) and concatenates the aggregated embeddings with the embedding of the current node and calculates a dot product with a weight matrix.

At block 413, the pipeline selects positive and negative samples with respect to each of the batch of related graph embeddings. The pipeline runs the sampler which iterates over the batch of graph embeddings and selects, for each graph embedding, the m positive samples and the m negative samples that satisfy the sampling parameters with respect to the graph embedding.

At block 415, the pipeline computes loss based on the batch of embeddings and samples. The pipeline then runs backpropagation based on the computed loss. While these example operations refer to backpropagation, embodiments can use another type of GNN that uses forward-forward learning, such as a GNN implemented according to the Graph Forward-Forward (GFF) algorithm or ForwardGNN algorithm.

At block 417, the pipeline determines whether there is another batch of graph embeddings to select. If there is another batch to select (i.e., if B batches have not been selected), then operational flow returns to block 407. Otherwise, operational flow proceeds to block 419.

At block 419, the pipeline determines whether the training epochs have completed. If the training epochs have completed, then operational flow ends for FIG. 4. Otherwise, operational flow returns to block 406.

FIG. 5 is a flowchart of example operations for detecting malicious domain campaigns based on the clustering of graph embeddings. For more accurate detection of malicious domain campaigns, the example operations analyze the clusters and filter the clusters to focus on the most toxic and most connected clusters.

At block 501, the pipeline sets clustering hyperparameters for cyberthreat campaign detection. For instance, the pipeline sets the minimum cluster size and epsilon, based at least partly on the data.

At block 503, the pipeline generates clusters of graph embeddings. The pipeline runs program code implementing a clustering algorithm. Examples of clustering algorithms that can be used include agglomerative clustering, k means clustering, density-based spatial clustering of applications with noise (DBSCAN), and hierarchical DBSCAN (HDBSCAN).

At block 505 (depicted in a dashed line), the pipeline measures toxicity of each cluster. Toxicity is measured based on proportion of known benign members and known malicious members. The pipeline then selects the k most toxic clusters.

Embodiments can set coefficients for toxicity measurement that increase toxicity for each malicious member and decreases toxicity for each benign member by an amount that does not completely counterweigh the malicious domain. For example, a proportion of malicious members in a cluster may be multiple by a coefficient of 2 while a proportion of benign members is multiplied by −1. The toxicity measurement or score would then sum the resulting values. With threat intelligence data, the pipeline can also account for reputations of domains (e.g., high or medium risk) and unknown domains. For instance, the pipeline can increase the toxicity measurement by different degrees depending upon reputation.

At block 507 (depicted in a dashed line), the pipeline cleans clusters. The pipeline can remove known benign domains from the clusters since their membership has already been accounted for in the toxicity measurement. However, embodiments may allow known benign domains to remain in the clusters to influence the similarity measurement.

At block 509, the pipeline analyzes lexical similarity and/or content similarity of domains. For lexical similarity, the pipeline can leverage the embeddings of a cluster and measure the difference between the embeddings for lexical similarity. The pipeline can instead (or in addition) use string similarity as a metric for domain similarity within a cluster. For content similarity, the pipeline collects or retrieves content of webpages of the domains in the cluster after creation of the graph. For example, the pipeline can generate a list of the domains in the second/homogeneous knowledge graph and submit the list of domains to a crawler (e.g., after the operation represented in block 207 in FIG. 2). The crawler can crawl the domains to retrieve content and feed that content into a feature generator to obtain the most up-to-date features of webpages of the domains. While the crawler and feature generator work, the pipeline can concurrently continue processing the graph, such as the string similarity evaluation and clustering operations. If the implementation has selected the k most toxic clusters, then the pipeline will measure similarity for only the selected clusters. For each analyzed cluster, the pipeline aggregates the similarities to obtain a similarity measurement for the cluster. For example, the pipeline averages the similarity measurements. If both lexical/string similarity measurements and content similarity measurements are computed, then embodiments can bias one of the types of similarity measurements by aggregating each type, weighting one or both aggregated similarities, and then aggregating the weighted similarities.

At block 511, the pipeline identifies which of the clusters has high similarity and indicates those clusters as cyberthreat campaigns. Identification of high similarity for a cluster can be based on a cluster similarity threshold.

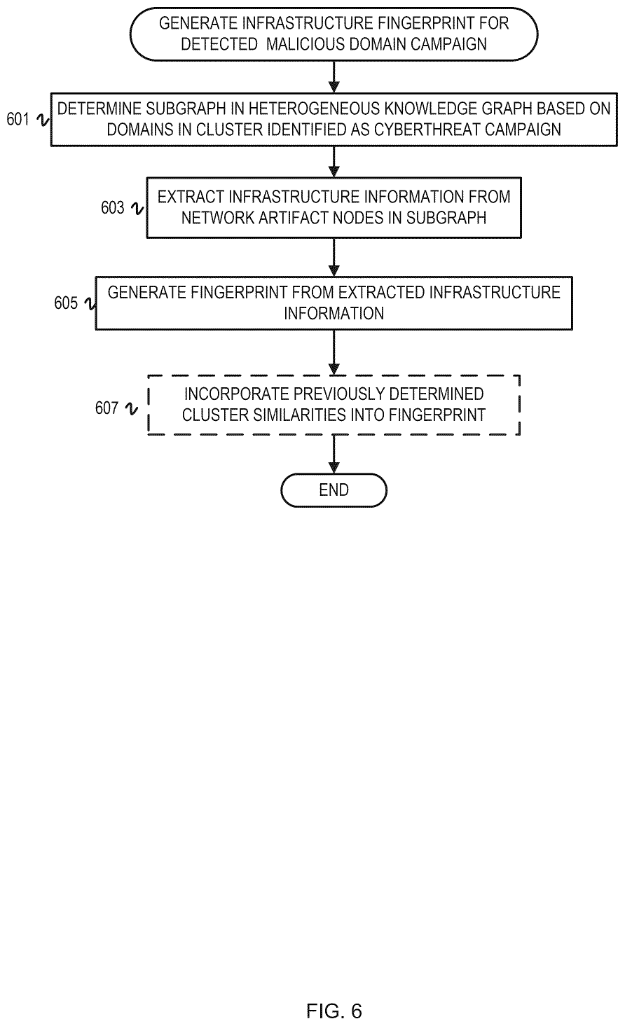

FIG. 6 is a flowchart of example operations for generating an infrastructure fingerprint for detected malicious domain campaigns. An infrastructure fingerprint can be used to rapidly determine whether a new domain is part of a malicious domain campaign or detect another malicious domain campaign that uses the same infrastructure. While the generation of the infrastructure fingerprint can be performed by the pipeline, the use of the fingerprint can be used by other scanning services/devices.

At block 601, the pipeline determines a subgraph in the heterogeneous knowledge graph based on domains in a cluster identified as a cyberthreat campaign. The pipeline performs a “reverse lookup” in the first knowledge graph for each of the domains in the cyberthreat campaign cluster. The determined subgraph includes the domains in the cyberthreat campaign cluster.

At block 603, the pipeline extracts infrastructure information from network artifact nodes in the subgraph. The pipeline traverses the subgraph and extracts the network addresses, certificates, and file signatures indicated in the network artifact nodes connecting the domains in the subgraph. The pipeline can also extract infrastructure information indicated in the enriched domain nodes, such as hosting information.

At block 605, the pipeline generates a fingerprint from the extracted infrastructure information. The fingerprint can be an object or list with key-value pairs corresponding to the extracted infrastructure information. Embodiments can create regular expressions from the extracted infrastructure information to be the fingerprints. For example, the pipeline can create a fingerprint that indicates a lexical pattern and hosting infrastructure (e.g., network address associations, certificate, and/or file signature) or a content pattern and hosting infrastructure. A fingerprint can be associated with matching criteria for determining whether a domain matches the fingerprint or computing a match confidence. For example, a matching network address and file signature may be sufficient for a high confidence match while a match of a network address alone is insufficient.

At block 607 (depicted in a dashed line), the pipeline incorporates the previously determined cluster similarities into the fingerprint. One component of a fingerprint can be a regular expression created from the most common characters or words determined from the measurement of string or lexical similarity of the domains in a cluster. Textual patterns or HTML document object model structural patterns can be extracted and incorporated into the fingerprint. As another example, a feature vector can be incorporated into the fingerprint according to the content. For instance, a feature vector can be generated from the content features of a cluster determined to represent the campaign. To determine whether a new domain is part of the campaign, a feature vector of the content features would be generated for the new domain and compared with the feature vector in the fingerprint (e.g., distance between vectors calculated).

### Variations

While the description refers to an example that searches for paths with 2 network artifact nodes in a path between domain nodes, embodiments can allow for other criteria to transform an indirect relationship between domains into a direct relationship. For instance, embodiments can allow for any number of intervening network artifact nodes between domain nodes to transform into a domain-domain relationship but with decreasing strength as the number of intervening network artifact nodes increases.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the cleaning depicted in block 507 can be performed after block 509. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

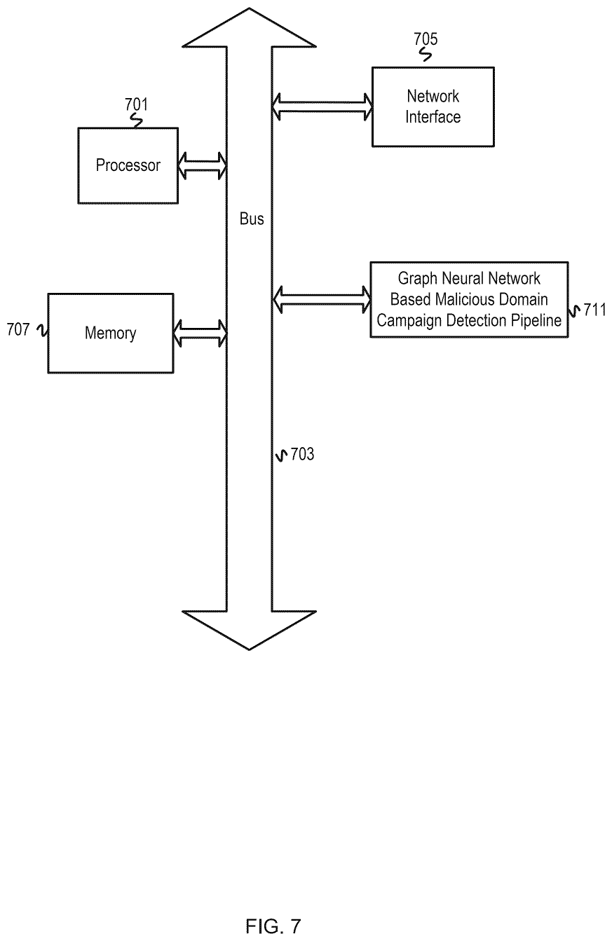

FIG. 7 depicts an example computer system with a GNN-based malicious domain campaign detection pipeline. The computer system includes a processor 701 (possibly including multiple processors, multiple cores, multiple nodes, and/or implementing multi-threading, etc.). The computer system includes memory 707. The memory 707 may be system memory or any one or more of the above already described possible realizations of machine-readable media. The computer system also includes a bus 703 and a network interface 705. The system also includes a GNN-based malicious domain campaign detection pipeline 711. The GNN-based malicious domain campaign detection pipeline 711 detects malicious domain campaigns based on clustering graph embeddings. The GNN-based malicious domain campaign detection pipeline 711 creates a first knowledge graph with nodes that represent malicious domains and expands upon these malicious domains with other domains and with network artifact nodes. The addition of the network artifacts and network artifact attributes in the form of nodes and edges relating to the domain nodes reveals relationships among the domains based on infrastructure shared by the network artifacts. The GNN-based malicious domain campaign detection pipeline 711 adds additional information of domain features. The GNN-based malicious domain campaign detection pipeline 711 creates a second graph that more succinctly expresses relationships among domains by converting indirect relationships/connection among domains via the network artifact nodes into direct relationships. The GNN-based malicious domain campaign detection pipeline 711 differentiates among the relationships that were direct domain-domain relationships by assigning stronger weights to those relationships and weaker weights to the domains that were related through multiple intermediate network artifact nodes. The GNN-based malicious domain campaign detection pipeline 711 generates feature vectors with the domain features information that was added to the domain nodes in the first graph and inputs these along with the second graph into a GNN. With unsupervised learning and sampling as previously described, the GNN learns an embedding space and becomes a trained GNN model for generating graph embeddings. The GNN-based malicious domain campaign detection pipeline 711 clusters these graph embeddings and analyzes the clusters to select clusters that are highly likely to be malicious domain campaigns. As a malicious domain campaign is identified through clustering based on shared infrastructure, the GNN-based malicious domain campaign detection pipeline 711 can use the infrastructure information common across cluster members to create a fingerprint for capturing new domains as part of a malicious campaign. Any one of the previously described functionalities may be partially (or entirely) implemented in hardware and/or on the processor 701. For example, the functionality may be implemented with an application specific integrated circuit, in logic implemented in the processor 701, in a co-processor on a peripheral device or card, etc. Further, realizations may include fewer or additional components not illustrated in FIG. 7 (e.g., video cards, audio cards, additional network interfaces, peripheral devices, etc.). The processor 701 and the network interface 705 are coupled to the bus 703. Although illustrated as being coupled to the bus 703, the memory 707 may be coupled to the processor 701.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

1. A method comprising:
building a first graph with nodes that represent a first set of domains that are malicious domains and network artifacts corresponding to the first set of domains and with edges indicating relationships among the nodes representing the first set of domains to nodes representing the network artifacts, wherein a network artifact comprises one of a shared certificate, network address, related domain, and malicious software;
associating values of domain features with those of the nodes representing domains;
transforming the first graph into a second graph, wherein the transforming comprises, for each path between domain nodes that only includes a single network artifact node creating an edge with a first weight between the domain nodes and for each path between domain nodes that only includes a sequence of two network artifact nodes creating an edge with a second weight between the domain nodes and removing the network artifact nodes;
generating, from the values of domain features, feature vectors for the nodes of the second graph representing domains;
generating graph embeddings from the feature vectors and the second graph, wherein the graph embedding reflects topology of the graph somehow (strength of connections);
clustering the graph embeddings; and
identifying one or more malicious campaigns based, at least partly, on the clustered graph embeddings.

2. The method of claim 1, wherein identifying the one or more malicious campaigns comprises, for each cluster, measuring similarity of cluster members, and filtering out a cluster member if measured similarity does not satisfy a set of one or more similarity measurement thresholds.

3. The method of claim 2, wherein measuring similarity comprises at least one of measuring lexical similarity and content similarity, wherein lexical similarity is with respect to domain names and content similarity is with respect to content of one or more web pages of the domains.

4. The method of claim 1 further comprising:
measuring toxicity of each cluster based, at least partly, on proportion of known malicious domains within the cluster and proportion of known benign domains within the cluster; and
selecting the k most toxic clusters,
wherein identifying the one or more malicious campaigns is limited to the selected k most toxic clusters.

5. The method of claim 1 further comprising extracting information from the first graph corresponding to domains in a cluster identified as a first malicious campaign to discover infrastructure supporting the first malicious campaign.

6. The method of claim 5 further comprising:
generating a fingerprint of the first malicious campaign from the discovered infrastructure information and from at least one of content features common across the domains of the first malicious campaign and one or more lexical features shared among domains of the first malicious campaign; and
evaluating a new domain against the fingerprint to determine whether the new domain is part of the first malicious campaign.

7. The method of claim 1, wherein building the first graph comprises, for each pair of nodes representing network addresses, determining whether the network addresses represented by the nodes are within a same subnet and adding an edge between the network address nodes if within a same subnet.

8. The method of claim 1 further comprising, for each pair of domain nodes in the second graph, determining whether an edit distance between the domains satisfies a distance threshold and adding an edge between the pair of domain nodes if the distance threshold is satisfied.

9. The method of claim 1 further comprising, at least one of, pruning the first graph to remove each connected component that does not satisfy a minimum node threshold and pruning the first graph to remove each node having an amount of adjacent nodes greater than a noise threshold.

10. The method of claim 1, wherein generating the graph embeddings comprises training a graph neural network according to unsupervised learning, wherein the training comprises:
selecting m positive samples for a first of the graph embeddings and m negative samples for the first graph embedding,
wherein selecting the m positive samples comprises selecting m of the graph embeddings that correspond to strongly connected nodes adjacent to a first node corresponding to the first graph embedding and wherein a strength threshold for edge weights delineates strongly connected nodes;
wherein selecting the m negative samples comprises selecting m of the graph embeddings that correspond to m of the nodes that are distant and weakly connected with respect to the first node and wherein a weak threshold for edge weights delineates weakly connected nodes and a distance threshold delineates distant nodes;
computing loss based on a difference in similarity of the positive samples and dissimilarity of the negative samples; and
backpropagating the loss.

11. A non-transitory, machine-readable medium having program code stored thereon, the program code comprising instructions to:
build a first knowledge graph of heterogeneous nodes comprising domain nodes and network artifact nodes, wherein the domain nodes at least represent a first set of domains that are malicious domains and a network artifact node represents one of a shared certificate, network address, related domain, and malicious software;
associate values of domain features with the domain nodes;
transform the first knowledge graph into a second knowledge graph of homogenous nodes comprising domain nodes, wherein the instructions to transform the first knowledge graph into the second knowledge graph comprise instructions to,
for each path between domain nodes that only includes a single network artifact node, create an edge with a first weight between the domain nodes,
for each path between domain nodes that only includes a sequence of two network artifact nodes, create an edge with a second weight between the domain nodes, and
remove the network artifact nodes;
generate, from the values of domain features, feature vectors for the domain nodes in the second knowledge graph;
obtain graph embeddings from a graph neural network with the feature vectors and the second knowledge graph;
cluster the graph embeddings; and
identify one or more malicious campaigns based, at least partly, on the clustered graph embeddings.

12. The non-transitory, machine-readable medium of claim 10, wherein the instructions to identify the one or more malicious campaigns comprise instructions to, for each cluster, measure similarity of cluster members, and filter out a cluster member if its measured similarity does not satisfy a set of one or more similarity measurement thresholds, wherein the instructions to measure similarity comprise at least one of instructions to measure lexical similarity among cluster members and instructions to measure web page content similarity across cluster members.

13. The non-transitory, machine-readable medium of claim 10, wherein the program code further comprises instructions to:
measure toxicity of each cluster based, at least partly, on proportion of known malicious domains within the cluster and proportion of known benign domains within the cluster; and
select the k most toxic clusters,
wherein the instructions to identify the one or more malicious campaigns is limited to the selected k most toxic clusters.

14. The non-transitory, machine-readable medium of claim 10, wherein the program code further comprises instructions to:
extract information from nodes in the first knowledge graph corresponding to domains in a cluster identified as a first malicious campaign to discover infrastructure of the first malicious campaign;
generate a fingerprint of the first malicious campaign from the discovered infrastructure information and from at least one of content features common across the domains of the first malicious campaign and one or more lexical features shared among domains of the first malicious campaign; and
evaluate a new domain against the fingerprint to determine whether the new domain is part of the first malicious campaign.

15. The non-transitory, machine-readable medium of claim 10, wherein the instructions to build the first knowledge graph comprise instructions to, for each pair of network artifact nodes representing network addresses, determine whether the network addresses represented by the network artifact nodes are within a same subnet and add an edge between the network artifact nodes if within a same subnet.

16. The non-transitory, machine-readable medium of claim 10, wherein the program code further comprises at least one of:
instructions to prune the first knowledge graph to remove each connected component that does not satisfy a minimum node threshold;
instructions to prune the first knowledge graph to remove each node having an amount of child nodes greater than a noise threshold; and
instructions to, for each pair of domain nodes in the second knowledge graph, determine whether an edit distance between the domains satisfies a distance threshold and add an edge between the pair of domain nodes if the distance threshold is satisfied.

17. An apparatus comprising:
a processor;
a machine-readable medium having stored thereon instructions executable by the processor to cause the apparatus to,
build a first knowledge graph of domain nodes and network artifact nodes, wherein the domain nodes at least represent a first set of domains that are malicious domains and each network artifact node represents one of a shared certificate, network address, related domain, and malicious software;
associate values of domain features with the domain nodes;
transform the first knowledge graph into a second knowledge graph of domain nodes, wherein the instructions to transform the first knowledge graph into the second knowledge graph comprise instructions to,
for each path between domain nodes that only includes a single network artifact node, create an edge with a first weight between the domain nodes,
for each path between domain nodes that only includes a sequence of two network artifact nodes, create an edge with a second weight between the domain nodes, and
remove the network artifact nodes;
generate, from the values of domain features, feature vectors for the domain nodes in the second knowledge graph;
obtain, with a graph neural network, graph embeddings from the feature vectors and the second knowledge graph;
cluster the graph embeddings; and
identify one or more malicious campaigns based, at least partly, on the clustered graph embeddings.

18. The apparatus of claim 17, wherein the instructions to identify the one or more malicious campaigns comprise instructions executable by the processor to cause the apparatus to, for each cluster, measure similarity of cluster members, and filter out a cluster member if its measured similarity does not satisfy a set of one or more similarity measurement thresholds, wherein the instructions to measure similarity comprise at least one of instructions to measure lexical similarity among cluster members and instructions to measure web page content similarity across cluster members.

19. The apparatus of claim 17, wherein the machine-readable medium further has stored thereon instructions executable by the processor to cause the apparatus to:
measure toxicity of each cluster based, at least partly, on proportion of known malicious domains within the cluster and proportion of known benign domains within the cluster; and
select the k most toxic clusters,
wherein the instructions to identify the one or more malicious campaigns is limited to the selected k most toxic clusters.

20. The apparatus of claim 17, wherein the machine-readable medium further has stored thereon instructions executable by the processor to cause the apparatus to:
extract information from nodes in the first knowledge graph corresponding to domains in a cluster identified as a first malicious campaign to discover infrastructure of the first malicious campaign;
generate a fingerprint of the first malicious campaign from the discovered infrastructure information and from, at least one of, content features common across the domains of the first malicious campaign and one or more lexical features shared among domains of the first malicious campaign; and
evaluate a new domain against the fingerprint to determine whether the new domain is part of the first malicious campaign.

21. The apparatus of claim 17, wherein the instructions to build the first knowledge graph comprise instructions executable by the processor to cause the apparatus to, for each pair of network artifact nodes representing network addresses, determine whether the network addresses represented by the network artifact nodes are within a same subnet and add an edge between the network artifact nodes if within a same subnet.

22. The apparatus of claim 17, wherein the machine-readable medium further has stored thereon at least one of:
instructions to prune the first knowledge graph to remove each connected component that does not satisfy a minimum node threshold;
instructions to prune the first knowledge graph to remove each node having an amount of adjacent nodes greater than a noise threshold; and
instructions to, for each pair of domain nodes in the second knowledge graph, determine whether an edit distance between the domains satisfies a distance threshold and add an edge between the pair of domain nodes if the distance threshold is satisfied.

23. The apparatus of claim 17, wherein the instructions to generate the graph embeddings comprise instructions executable by the processor to cause the apparatus to train a graph neural network according to unsupervised learning, wherein the training instructions comprise instructions executable by the processor to cause the apparatus to:
select m positive samples for a first of the graph embeddings and m negative samples for the first graph embedding,
wherein the instructions to select the m positive samples comprise instructions executable by the processor to cause the apparatus to select m of the graph embeddings that correspond to strongly connected nodes adjacent to a first node corresponding to the first graph embedding and wherein a strength threshold for edge weights delineates strongly connected nodes;
wherein the instructions executable by the processor to cause the apparatus to select the m negative samples comprise instructions executable by the processor to cause the apparatus to select m of the graph embeddings that correspond to m of the nodes that are distant and weakly connected with respect to the first node and wherein a weak threshold for edge weights delineates weakly connected nodes and a distance threshold delineates distant nodes;
compute loss based on a difference in similarity of the positive samples and similarity of the negative samples; and
backpropagate the loss.
